(19) United States
(12) Patent Application Publication
(10) Pub. No.: US 2007/0164002 A1
(43) Pub. Date: Jul. 19, 2007

(54) Manufacture of hardfaced plates

(76) Inventors: Jean-Louis Scandella, Holtzwihr (FR); Michael Paul Simpson, Cambridgeshire (GB); Leslie Whitemore, Hertfordshire (GB)

Correspondence Address: Fildes & Outland, 20916 Mack Avenue, Suite 2, Gross Pointe Woods, MI, 48236, US

(21) Appl. No.: 10/576,539

(22) PCT Filed: Oct. 21, 2003
(86) PCT No.: PCT/GB03/04562

§ 371 Date: Jan. 19, 2007

(51) Int. Cl. B23K 9/04

(52) U.S. Cl. 219/76.14

(57) ABSTRACT

A method of manufacturing a hardfaced plate (1) by applying a cladding (3) to a surface of a substrate (40) by arc welding, the method comprising moving the substrate (4) and a continuous arc welding wire feed (23) relative to each other, wherein the welding wire feed (23) is in a direction generally transverse to said given direction of relative movement. The welding wire can be fed by a welding gun (23) to the surface of the substrate (4) to be clad from one side of the given direction of relative movement at an acute angle to the surface of the substrate (40).

This invention relates to the manufacture of hardfaced plates which comprise a metallic substrate clad on at least one major surface thereof, by arc welding, with a hard wearing, oxidation- and/or corrosion-resistant material, such as a steel, low-alloy ferrous material, iron or a high-alloy ferrous material, cobalt-based alloy, nickel-based alloy or a copper-based alloy.

Hardfaced plates are used in harsh and demanding working environments where resistance to abrasion, adhesion, erosion, cavitation, oxidation and/or other corrosion is important. Typical manufacturing techniques for these plates involve a cladding operation by arc welding to the surface(s) of a comparatively inexpensive and less durable substrate, usually in sheet or plate form which, after cladding, can be either cut to size and/or shaped to required dimensions for the manufacture of various products such as tubes, elbows and the like.

The process by which these hardfaced plates are manufactured, involves welding in which an arc is established between a continuously-fed solid or tubular welding wire and the associated weld pool on the substrate or the substrate itself, for example, an open-arc welding process. If necessary, an inert gas can be used to shield the weld pool, for example, a Mig/Mag welding process. Also, tubular welding wires, with or without flux contained in the core, can be used, depending upon manufacturing and/or operating requirements and conditions.

The arc welding process is a function of several parameters, such as, the welding current, arc voltage, relative speed between the welding gun and substrate, the angle between the gun and the substrate and the distance between the tip of the welding gun and the substrate, sometimes known as the “stickout distance”.

To be able to produce hardfaced plates by arc welding, the ability to monitor and control at least one and preferably at least some of these welding parameters is critical, particularly when thin hardfaced plates are required.

Hardfaced plates of 5 mm thickness and above are well known.

In certain circumstances, however, particularly where weight is important, plates with thicknesses of less than, say, 5 mm are required. The difficulty in reducing the thickness of the plates is associated with the dilution of the welding and substrate metals during the arc welding process, due to high heat input which tends to burn through the substrate. Wear resistant plates less than 5 mm in thickness are available in cast form but they offer limited durability and hence short working life, due mainly to their low alloy content.

Since there is no proven method for manufacturing thin hardfaced plates of less than 5 mm in thickness by arc welding, the techniques of a) producing thick hardfaced plates and machining off the excess cladding material after manufacture or b) producing by powder spraying or plasma welding, are very expensive and impractical.

It is an object of the present invention to provide an improved method for manufacturing hardfaced plates with thicknesses of less than 5 mm.

It is another object of the invention to provide a method of manufacturing thin hardfaced plates which are capable of being deformed into different shapes without the substrate cracking or breaking and without the cladding material peeling off or otherwise separating from the substrate.

Accordingly, a first aspect of the invention provides a method of manufacturing a hardfaced plate by applying a cladding to a surface of a substrate by arc welding, the method comprising moving the substrate and a continuous arc welding wire feed relative to each other, wherein the welding wire feed is in a direction generally transverse to said given direction of relative movement.

Preferably, welding wire is fed by a welding gun to the surface of the substrate to be clad from one side of the given direction of relative movement at an acute angle to the surface of the substrate.

A second aspect of the invention resides in a method of manufacturing a hardfaced plate by applying a cladding to a surface of a substrate by arc welding, the method comprising moving the substrate and a continuous arc welding wire feed relative to each other in a given direction, wherein the welding wire feed is at an acute angle to that surface, preferably transversely of the given direction of relative movement.

In both the first and second aspects of the invention, the cladding applied to the surface of the substrate is in the form of a continuous weld bead or a plurality of side-by-side weld beads whose profile(s) may be monitored. Such monitoring may be carried out as part of a procedure to maintain a desired profile for the cladding, whereby the so-monitored information may be used to adjust at least one working parameter of the method, for example, at least one of the welding current, arc voltage, relative welding gun and substrate speeds, gun angle and stickout distances. Also, in each aspect, the substrate is preferably cylindrical and is rotated about a generally horizontal axis with respect to the welding wire feed.

A third aspect of the invention provides a method of manufacturing a hardfaced plate by applying a cladding to a surface of a substrate by arc welding, which method comprises forming the substrate into a cylindrical shape, rotating the so-formed cylindrical substrate about a substantially horizontal axis, and applying continuous arc welding wire feed to the surface of the rotating substrate at a level below the uppermost level of the rotating cylindrical substrate.

Preferably, welding wire is fed by a welding gun to the surface of the rotating substrate to be clad at an acute angle to that surface, preferably transversely to the direction in which the substrate is rotating.

Similar to the first and second aspects of the invention defined above, the cladding applied to the surface of the rotating substrate may be in the form of a continuous weld bead or a plurality of side-by-side weld beads whose profile(s) may be monitored. Such monitoring may be carried out as part of a procedure to maintain a desired profile for the cladding, whereby the monitored information may be used to adjust at least one working parameter of the method, for example, at least one of the welding current, arc voltage, relative welding gun and substrate speeds, gun angle and stickout distances.

Accordingly, a fourth aspect of the invention resides in apparatus for manufacturing a hardfaced plate by applying a cladding to a surface of a substrate by arc welding, the apparatus comprising means arranged to move a substrate and a continuous arc welding wire feed relative to each other and means arranged to direct the welding wire feed in a direction generally transverse to said given direction of relative movement.

Preferably, welding wire is arranged to be fed by a welding gun to the surface of the substrate to be clad from one side of the given direction of relative movement at an acute angle to the surface of the substrate.

A fifth aspect of the invention resides in apparatus for manufacturing a hardfaced plate by applying a cladding to a surface of a substrate by arc welding, the apparatus comprising means arranged to move the substrate and a continuous arc welding wire feed relative to each other in a given direction and means arranged to direct the welding wire feed at an acute angle to the substrate surface to be clad, preferably transversely of said given direction of relative movement.

A sixth aspect of the invention resides in apparatus for manufacturing a hardfaced plate by applying a cladding to a surface of a substrate by arc welding, which apparatus comprises rotatable means arranged to receive thereon a substrate to be clad, means for rotating the rotatable means, and hence a substrate received thereon, about a generally horizontal axis, and means arranged to apply, in use, continuous arc welding wire feed to the surface of the rotating substrate at a level below the uppermost region of the rotating substrate surface.

Preferably, welding wire is arranged to be fed by a welding gun to the surface of the substrate to be clad from one side of the direction of rotation of the substrate in use, preferably at an acute angle to the rotating substrate surface.

In the fourth, fifth and sixth aspects of the invention, further means may be provided for applying the cladding to the surface of the substrate in the form of a continuous weld bead or a plurality of side-by-side weld beads whose profile(s) may be monitored. Such monitoring may be carried out by additional means as part of a procedure to maintain a desired profile for the cladding, whereby the monitored information may be supplied to yet further means for adjusting at least one working parameter of the method, for example, at least one of the welding current, arc voltage, relative welding gun and substrate speed, gun angle and stickout distances.

In an embodiment to be described in more detail hereinbelow, and when the substrate to which an arc-welded cladding is to be applied, is secured to the outer surface of a drum rotatable about a generally horizontal axis, so that the substrate, and hence its surface to be clad, is moved with respect to an arc welding gun which is spaced from but movable across the surface of the substrate, that is to say, axially of the rotating cylindrical substrate.

The wire feed may be oscillated transversely to the direction of relative movement between the substrate surface and the welding gun. In this manner, the weld bead(s) applied to the surface of the substrate tends to be slightly wider and flatter than a weld bead(s) applied without oscillation of the wire feed.

Also, and as mentioned above, the welding wire feed can be carried out below the uppermost level of the rotating substrate, in contrast to prior art arrangements wherein the welding wire feed, namely, the arc welding gun, is located above the uppermost level of the rotating substrate, generally normal thereto.

In order that the invention may be more fully understood, a preferred method of manufacturing, and associated apparatus, in accordance therewith will now be described by way of example and with reference to the accompanying drawings in which:

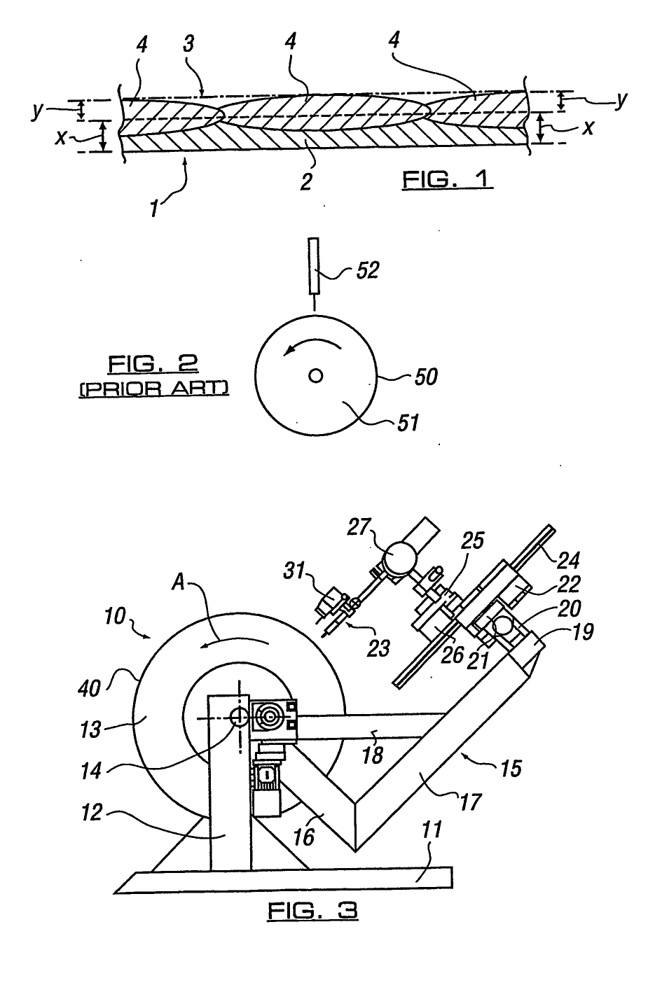

FIG. 1 is a sectional view of a portion of a thin hardfaced plate;

FIG. 2 is a diagrammatic view of a prior art apparatus for cladding a substrate by arc welding;

FIG. 3 is a side elevation of apparatus for manufacturing the thin hardfaced plate shown in FIG. 1;

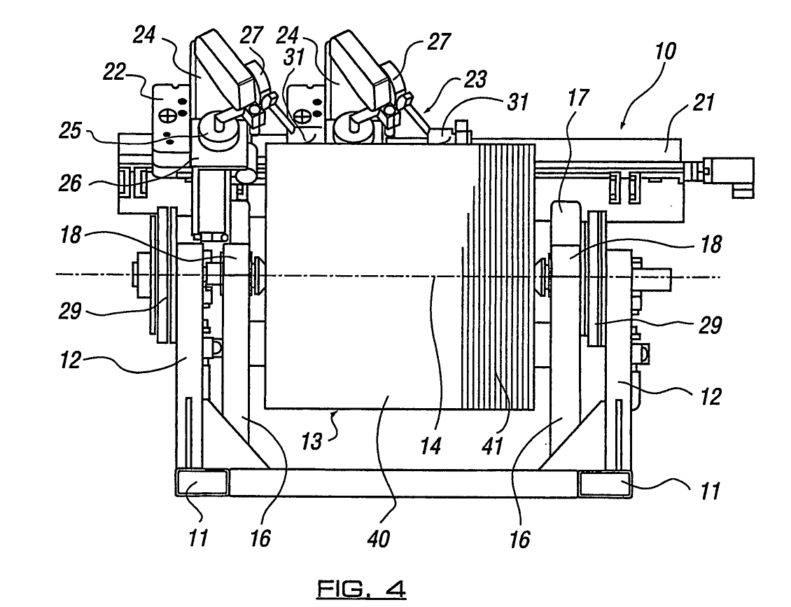

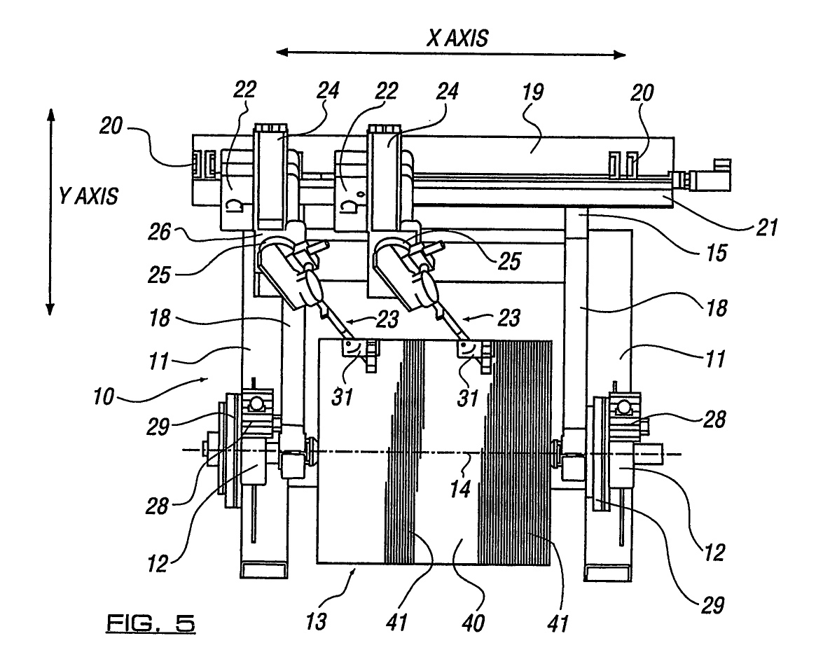

FIG. 4 is a front elevation of the apparatus shown in FIG. 3; and

FIG. 5 is a plan of the apparatus shown in FIGS. 3 and 4.

Referring firstly to FIG. 1 of the accompanying drawings, a thin hardfaced plate, indicated generally at 1, has been manufactured in accordance with the invention and comprises a metallic substrate 2 of a suitable metallic material, such as a steel.

A cladding, indicated generally at 3, has been applied to the upper surface of the substrate 2, that cladding 3 being in the form of arc welded beads 4 of any suitable metallic material, such as a steel, low-alloy ferrous material, iron or a high-alloy ferrous-material or a cobalt-, nickel- or copper-based alloy.

The thickness of the metallic substrate 2 before cladding is represented by the distance x which is preferably no more than 4 mm, whilst the thickness of the cladding 3 is represented by the distance y which excludes the depth of penetration of the cladding beads 4 into the upper surface of the substrate 2.

The thickness y is preferably no greater than 2 mm.

A thin hardfaced plate 1 having a thickness x+y totalling, say, 5 mm, where x is 3 mm and y is 2 mm, is known as a “3+2 plate”.

Referring now to FIGS. 3 to 5 of the accompanying drawings, apparatus for manufacturing a thin hardfaced plate, such as that shown at 1 in FIG. 1, is indicated generally at 10 and comprises a rigid base 11 upon which is mounted, via a pair of spaced uprights 12, a drum 13 which is rotatable about a horizontal axis 14, in the anticlockwise direction of arrow A, upon bearings (not shown) provided in respective uprights 12.

A tiltable frame, indicated generally at 15, comprises spaced pairs of arms 16, 17 on respective opposed sides of the base 11, connected together at their lower ends and, also, by a stay member 18.

The upper left hand end of the arm 16 is mounted to the axis 14 for pivotal movement with respect thereto, so that the frame 15, and components mounted thereon, can be tilted up and down.

The upper ends of the pair of arms 17 of the frame 15 are connected together by a cross member 19 upon which is mounted spacers 20 and on to these is mounted a beam 21 which defines the X axis of the apparatus 10.

A carriage 22 is mounted slidably or racked upon the beam 21 for moving its corresponding welding gun 23 in the X axis direction and a guide beam 24 is mounted on the carriage 22 to provide movement towards and away from the drum 13, which defines the Y-axis of the apparatus 10.

Movably mounted upon each guide beam 24 is an arc welding gun, indicated generally at 23, with adjustable movement of each welding gun 23 along its guide beam 24 parallel to the Y axis of the apparatus.

Also, each welding gun 23 is mounted pivotally at 25 to a mounting 26 movable linearly along its corresponding guide beam 24 in the Y axis direction and extends at an acute angle to the surface of a substrate 40 mounted to the drum 13, for delivering welding wire 30 to the substrate surface.

Each welding gun 23 is mounted adjustably at 26 for linear movement towards and away from the drum 13 and, also, at 25 for pivotal movement. Such adjustments may be carried out manually at set-up.

Attached to each welding gun 23 is a sensor 31 for monitoring, by thickness, the profile of cladding applied by arc welding to the substrate 40 mounted to the drum 13, as will be described in more detail hereinbelow.

Additionally, welding wire feed is required to be uninterrupted, highly accurate and consistent during the arc welding operation. A wire feed mechanism 27 consists of drive rollers which ensure that the wire (not shown) does not slip and is fed positively through the welding gun 23 at all times during the welding operation and includes a sensor (also not shown) for monitoring the welding wire being fed to each gun 23.

Drive elements, such as slewing rings 29, are provided for rotating the drum 13 about its axis 14 and associated with each drive element 29 is a rotational speed and angular positioning sensor 28.

In operation of the apparatus 10, a sheet is substrate of a ferrous material and 2 mm in thickness is applied around and secured to the cylindrical surface of the drum 13, as indicated above and shown at 40.

The material from which the drum 13 is made is preferably suitable to act as a heat sink for the subsequent arc welding operation.

The angular orientation of the frame 15, and hence that of the welding guns 23, with respect to the cylindrical substrate 40 is adjusted, so that the required acute angle between the guns 23 and the surface of the substrate 40 is achieved, while a constant stickout distance is maintained.

This procedure is carried out at 24 for Y-axis adjustment and at 25 for pivotal adjustment, so that, in combination with the angular orientation of the frame 15, the two welding guns 23 are at the desired acute operating angle transverse to the direction of rotation of the cylindrical substrate 40 and amount of stickout.

This procedure provides the desired set-up of the welding guns 23 in the directions of both the X and Y axes.

Once the arc has been struck between each welding gun 23 and the surface of the cylindrical substrate 40, welding wire is fed continuously from each welding gun 23, to provide a continuous weld bead upon the surface of the rotating substrate 40.

In this method, the substrate 40 could be low alloy steel or high alloy steel or iron or cast iron, or nickel, cobalt and copper based materials. The welding wire could also have different chemistry, iron-based, nickel and cobalt-based alloys being the most common type welding wire.

Simultaneously, the weld guns 23 are moved in the direction of the X axis along the member 21, so that the two weld beads 41 are applied across substantially the whole of the surface of the substrate 40.

In FIG. 2, there is shown diagrammatically prior art apparatus in which the cylindrical substrate 50 upon the rotating drum 51 has the welding gun 52 located above the uppermost portion of the surface of the substrate 50.

In contrast, the embodiment of apparatus 10 shown in FIGS. 3 to 5, has the welding tip of each welding gun 23 located below that uppermost level of the surface of the rotating substrate 40.

This arrangement allows for a faster cladding process, in that the molten weld beads 41 applied to the rotating substrate 40 have enough time to solidify to a sufficient extent to prevent them from detaching themselves under gravity from the substrate 40 as they are rotated to the side of the apparatus 10 remote from the respective welding guns 23.

Thus, due to its comparatively high speed and comparatively low heat input, this arc welding cladding process allows the weld metal to cool down rapidly, with carbide distribution in the weld pools being extremely fine, thereby providing high cladding hardness and abrasion resistance.

As indicated above, this arc welding cladding method is dependent upon several operating parameters, namely:
1. Welding current which is proportional to the electrode/wire feed rate for a specific weld wire diameter, composition and stickout distance. A suitable, constant voltage power source, or any other appropriate power source, is used to melt the wire at a rate which maintains the preset output voltage. If other welding conditions are maintained constant, welding changes will have the following affects:
   increasing current will increase the wire deposition rate;
   increasing current will increase surface penetration of the substrate and the heat input;
   excessive current will produce convex weld beads with unacceptable bead appearance; and/or
   insufficient current will produce excessive spatter.
2. Arc voltage is the sum of the voltage drop through the welding cables, wire stickout, the arc, the substrate and the rotary earth, and any other components in series with the welding power source. If other welding conditions are maintained constant, changing the arc voltage will have the following affects:
   too high an arc voltage will result in a wide and irregularly shaped weld bead;
   too high an arc voltage may cause porosity in the cladding formed by the weld bead(s);
   too low an arc voltage may generate excessive spatter and poor weld bead performance;
   too low an arc voltage may result in a reduced penetration and lack of fusion; and/or
   too high an arc voltage may increase the heat input causing deformation of the substrate.
3. Stickout distance is the wire length between the welding tip and the substrate, which is resistance heated in proportion to its length. The stickout distance affects the arc energy, wire deposition rate and weld bead appearance and penetration.
4. Speed of travel, in this case rotational speed, influences the weld bead profile, heat input and penetration of the substrate surface.
5. Head and gun angles influence the weld bead profile.

Thus, and in order to maintain the desired weld bead, and hence cladding, profile, those parameters need to be adjusted from time to time.

Accordingly, the sensor 31 monitors the profile of the weld beads 41 and the resulting information is used to adjust accordingly one or more of the welding current, arc voltage, stickout distance, speed of rotation and head and gun angle.

The thin hardfaced plates manufactured by the above method and apparatus can be rolled to diameters as low as 100 mm and two opposed ends of the plates can be joined, again using an arc welding techniques, to produce internally clad hardfaced pipes. It is also possible to clad thin substrate plates on both sides, to produce double-sided thin hardfaced plates.

1. A method of manufacturing a hardfaced plate by applying a cladding to a surface of a substrate by arc welding, the method comprising moving the substrate and a continuous arc welding wire feed relative to each other, wherein the welding wire feed is in a direction generally transverse to said given direction of relative movement.

2. A method according to claim 1, wherein the welding wire is fed by a welding gun to the surface of the substrate to be clad from one side of the given direction of relative movement at an acute angle to the surface of the substrate.

3. A method according to claim 1, wherein the cladding applied to the surface of the substrate is in the form of a continuous weld bead or a plurality of side-by-side weld beads.

4. A method according to claim 3, wherein the profile(s) of the weld bead(s) is monitored.

5. A method according to claim 4, wherein said monitoring is carried out as part of a procedure to maintain a desired profile for the cladding.

6. A method according to claim 4, wherein the so-monitored information is used to adjust at least one working parameter of the method.

7. A method according to claim 6, wherein at least one of the welding current, arc voltage, relative welding gun and substrate speeds, gun angle and stickout distances is adjusted.

8. A method according to claim 1, wherein the substrate is cylindrical and is rotated about a generally horizontal axis with respect to the welding wire feed.

9. A method of manufacturing a hardfaced plate by applying a cladding to a surface of a substrate by arc welding, the method comprising moving the substrate and a continuous arc welding wire feed relative to each other in a given direction, wherein the welding wire feed is at an acute angle to that surface.

10. A method according to claim 9, wherein the welding wire feed is transverse of the given direction of relative movement.

11. A method according to claim 9, wherein the cladding applied to the surface of the substrate is in the form of a continuous weld bead or a plurality of side-by-side weld beads.

12. A method according to claim 11, wherein the profile(s) of the bead(s) is monitored.

13. A method according to claim 12, wherein said monitoring is carried out as part of a procedure to maintain a desired profile for the cladding.

14. A method according to claim 12, wherein the so-monitored information is used to adjust at least one working parameter of the method.

15. A method according to claim 14, wherein at least one of the welding current, arc voltage, relative welding gun and substrate speeds, gun angle and stickout distances is adjusted.

16. A method according to claim 9, wherein the substrate is cylindrical and is rotated about a generally horizontal axis with respect to the welding wire feed.

17. A method of manufacturing a hardfaced plate by applying a cladding to a surface of a substrate by arc welding, which method comprises forming the substrate into a cylindrical shape, rotating the so-formed cylindrical substrate about a substantially horizontal axis, and applying continuous arc welding wire feed to the surface of the rotating substrate at a level below the uppermost level of the rotating cylindrical substrate.

18. A method according to claim 17, wherein welding wire is fed by a welding gun to the surface of the rotating substrate to be clad at an acute angle to that surface.

19. A method according to claim 17, wherein welding wire is fed to the substrate surface transversely to the direction in which the substrate is rotating.

20. A method according to claim 17, wherein the cladding applied to the surface of the rotating substrate is in the form of a continuous weld bead or plurality of side-by-side weld beads.

21. A method according to claim 20, wherein the profile(s) of the bead(s) is monitored.

22. A method according to claim 21, wherein said monitoring is carried out as part of a procedure to maintain a desired profile for the cladding.

23. A method according to claim 21, wherein the monitored information is used to adjust at least one working parameter of the method.

24. A method according to claim 23, wherein at least one of the welding current, arc voltage, relative welding gun and substrate speeds, gun angle and stickout distances is adjusted.

25. Apparatus for manufacturing a hardfaced plate by applying a cladding to a surface of a substrate by arc welding, the apparatus comprising means arranged to move a substrate and a continuous arc welding wire feed relative to each other and means arranged to direct the welding wire feed in a direction generally transverse to said given direction of relative movement.

26. Apparatus according to claim 25, wherein welding wire is arranged to be fed by a welding gun to the surface of the substrate to be clad from one side of the given direction of relative movement at an acute angle to the surface of the substrate.

27. Apparatus for manufacturing a hardfaced plate by applying a cladding to a surface of a substrate by arc welding, the apparatus comprising means arranged to move the substrate and a continuous arc welding wire feed relative to each other in a given direction and means arranged to direct the welding wire feed at an acute angle to the substrate surface to be clad.

28. Apparatus according to claim 27, wherein said welding wire feed directing means is arranged to direct the welding wire feed transversely of said given direction of relative movement.

29. Apparatus for manufacturing a hardfaced plate by applying a cladding to a surface of a substrate by arc welding, which apparatus comprises rotatable means arranged to receive thereon a substrate to be clad, means for rotating the rotatable means, and hence a substrate received thereon, about a generally horizontal axis, and means arranged to apply, in use, continuous arc welding wire feed to the surface of the rotating substrate at a level below the uppermost region of the rotating substrate surface.

30. Apparatus according to claim 29, wherein welding wire is arranged to be fed by a welding gun to the surface of the substrate to be clad from one side of the direction of rotation of the substrate in use.

31. Apparatus according to claim 30 including means arranged to feed welding wire at an acute angle to the rotating substrate surface.

32. Apparatus according to claim 29, wherein an arc welding gun is spaced from but movable across the surface of the substrate axially of the rotating cylindrical substrate, in use.

33. Apparatus according to claim 25 including further means arranged to apply the cladding to the surface of the substrate in the form of a continuous weld bead or a plurality of side-by-side weld beads.

34. Apparatus according to claim 33 including further means arranged to monitor the profile(s) of the bead(s).

35. Apparatus according to claim 34 comprising additional means arranged to carry out said monitoring as part of a procedure to maintain a desired profile for the cladding.

36. Apparatus according to claim 34 including further means for adjusting at least one working parameter of the method in dependence upon monitored information.

37. Apparatus according to claim 25 including means arranged to oscillate the wire feed transversely to the direction of relative movement between the substrate surface and a or the welding gun.
